(19) United States
(12) Patent Application Publication
(10) Pub. No.: US 2005/0257131 A1
(43) Pub. Date: Nov. 17, 2005

(54) Frame environment that supports the navigation buttons of a web browser

(76) Inventors: Jing Yee Lim, Santa Clara, CA (US); Paul Buchheit, Mountain View, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/777,565

(22) Filed: Feb. 11, 2004

(51) Int. Cl. G06F 17/24

(52) U.S. Cl. 715/501.1

(57) ABSTRACT

A system and method for providing a frame environment that supports navigation between the various views that have been displayed in the frame environment using the forward and back buttons of the web browser.

### BACKGROUND

A. Technical Field

The present invention relates generally to Internet technology, and more particularly, to an HTML frame environment that provides web browser history entries for the various views loaded into the frame environment.

B. Background of the Invention

As the number of people accessing information through the World Wide Web continues to increase, content providers continue to look for better ways to present information to users. Most web pages are written using the HyperText Markup Language (HTML). HTML allows content providers to define how to present text, images, hypertext links and other elements to a user within a web page. A software application, called a web browser, interprets the HTML code and displays the web page to a user through a display such as a monitor connected to the user's computer.

One way to format contents for a particular web page is through the use of frames. HTML includes a FRAMESET tag that allows a content provider to define multiple frames for a web page. The contents of these frames can be defined independently and can be changed without changing the contents of the other frames. These frames may be visible to the user or may be hidden from the user. Often, visible frames are used to display content to the user while hidden frames contain code that provides added functionality for the web page.

In a conventional frameset environment, the frames are static. The size and layout of the frames do not change. For conventional framesets, the browser maintains history entries within the browser history for each frame of the frameset. The browser's history includes an entry for each web page the browser has loaded. Typically, this entry consists of the URL associated with the web page. These history entries are listed in the order in which the web pages were loaded by the browser. The browser uses these history entries to determine which pages to load when the user clicks on the navigation buttons of the web browser. The navigation buttons include the forward or back buttons found on most web browsers.

In a dynamic frame environment, where the size and the layout of the frames change, the browser records history entries for the various frames but does not record the size and/or layout of the frames. When a user navigates to a frame using the forward and back buttons of the web browser, the web browser loads the URL of the next or previous history entry, respectively, into the current frame. However, the browser does not restore the size and/or layout of the frame to its original size and/or layout. In some applications, this may be undesirable to a user because the web browser does not function as expected when pages are displayed in frames; thereby limiting the use of frames by content providers.

Accordingly, what is desirable is improved systems and methods for addressing the above-described limitations of prior systems.

### SUMMARY OF THE INVENTION

The present invention provides a frame environment that supports navigation between the various views displayed in the frame environment using the forward and back buttons of a web browser. In one embodiment, the frame environment is defined as an HTML frameset with multiple frames including a display frame, a history frame and a control frame. The display frame is a visible frame that displays a view to a user.

According to one embodiment, the control frame may contain code that detects user actions within the display frame and loads the appropriate view into the display frame in response to the user action. In one embodiment, when a user clicks on a link in the view displayed in the display frame, the control frame may create a new frame. A request for the contents of the view associated with the link may be requested from a remote server and loaded into the new frame. The contents may be loaded into the new frame such that the browser does not record a history entry for the new frame. The control frame may also cause a history entry to be entered into the browser's history for the history frame. In one embodiment, the control, frame may navigate the history frame to a URL that is associated with the current view. This may result in the creation of a history page that may comprise the contents of the history frame. When the history frame URL changes, the browser may create an entry for the URL in the browser history.

According to one embodiment, the history page may contain code that is executed by the web browser when the history page is loaded in the history frame. In one embodiment, the history page may be loaded when the user clicks on the forward or back buttons of a browser. When the user clicks on the forward or back button, the browser may navigate to the next or previous URL, respectively, in the browser's history. When the browser loads the URL associated with a history page, code within the history page may notify the control frame to load the view associated with the history page. In one embodiment, the code within the history page may send the URL of the history page to the control frame.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a frame environment 100 according to one embodiment of the invention.

FIG. 2 illustrates navigation within a frame environment according to one embodiment of the invention.

FIG. 3 illustrates frame environment 300 displaying the msg1 view.

FIG. 4 illustrates navigation within the frame environment according to one embodiment of the invention.

FIG. 5 is a flowchart illustrating one embodiment of a method for associating a view with an entry in a web browser's history.

### DETAILED DESCRIPTION

According to an embodiment, a frame environment that supports navigating between the various views displayed in a frame environment using the navigation buttons, such as the forward and back buttons, of a web browser is described. In one embodiment, a history frame associates a history page with each view displayed in the frame environment. The URL of the history frame may be updated by a control frame when a new view is displayed in the frame environment. The web browser may load the URL of the history frame as an entry in the browser's history and a corresponding history page may be cached. When the user navigates using the back and forward buttons of the browser, the browser may load the previous or next URL, respectively, stored in the browser's history. When the URL of a history page is loaded by the browser, the browser may load the cached history page. The history page may include code that is executed by the browser when the page is loaded. The code may also notify the control frame to make the view associated with the history page visible in a frame that is displayed to a user.

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, exemplary ones of which are described below, may be utilized in any device that supports a web browser architecture. Accordingly, structures and devices shown below in block diagram are illustrative of specific embodiments of the invention and are meant to avoid obscuring the invention.

Reference in the specification to “one embodiment,” “this embodiment” or “an embodiment” means that a particular feature, structure, characteristic, or function described in connection with the embodiment is included in at least one embodiment of the invention. The appearances of the phrase “in one embodiment” or “in an embodiment” in various places in the specification are not necessarily all referring to the same embodiment.

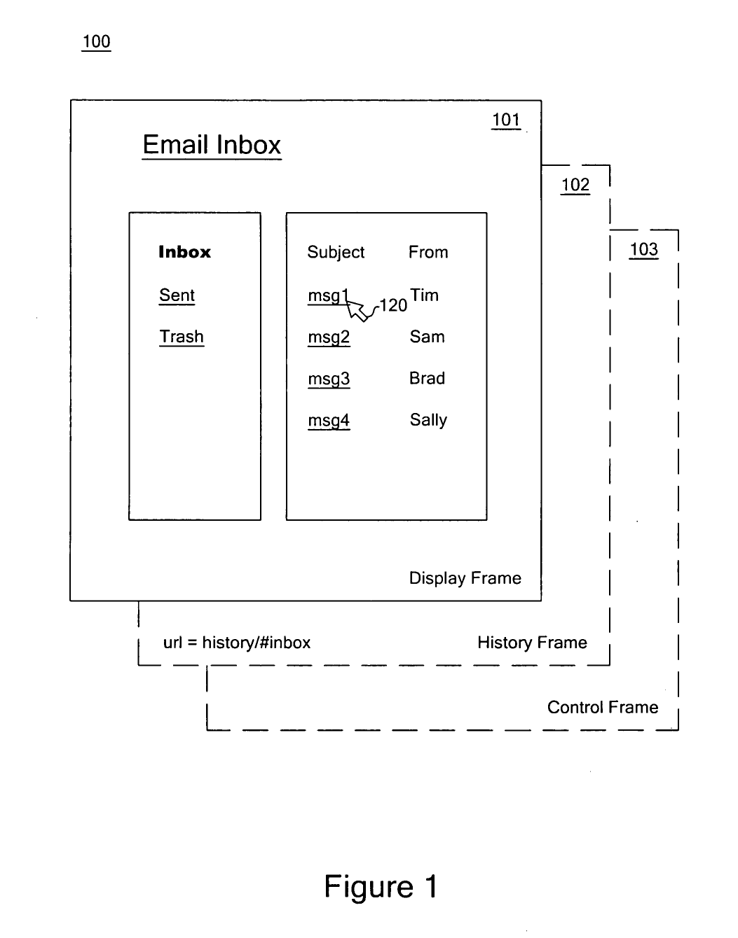

FIG. 1 provides a visual representation of a frame environment 100 in which embodiments of the invention may operate according to an embodiment of the invention. In one embodiment, frame environment 100 may be created using HTML frames and may be displayed in a web browser, such as Microsoft's Internet Explorer or the Netscape Navigator. In another embodiment, frame environment 100 may comprise inline frames, or IFRAMES, or a combination of frames and IFRAMES.

As illustrated in FIG. 1, frame environment 100 may comprise a frameset of three frames, display frame 101, history frame 102 and control frame 103. To aid in the understanding of the invention, frame environment 100 will be described with reference to various views relating to an email program. It should be noted that the invention is not limited to email applications or displaying views of an email program and can be used with any HTML contents loaded as a view.

According to an embodiment, display frame 101 may display the contents of a view, to the user. A view may consist of data that can be displayed to a user, including but not limited to a web page. In one embodiment, the view may be displayed in an IFRAME within display frame 101. In one embodiment shown in FIG. 1, an inbox view of an email program may be displayed in display frame 101. The user may navigate within display frame 101 using cursor 120, controlled by an input device, such as a mouse or similar pointing device. In this example, the inbox view may include links that the user may click or otherwise select to navigate to a new view. The links found within the inbox view in FIG. 1, for example, may include a link to the user's sent items folder, a link to the user's trash folder and links to four messages in the inbox, msg1, msg2, msg3 and msg4. By clicking on the various links within the view, the user can navigate to a new view associated with the link.

Control frame 103 may contain code that controls navigation within the frame environment 100. In one embodiment, control frame 103 may not be visible to the user. The code of control frame 103 may detect when a user clicks on a link within the view displayed in display frame 101 and may respond by loading the view associated with the link into display frame 101. For example, if a user clicks on a link in display frame 101, the code in control frame 103 may respond to the click by first determining if the view corresponding to the link has been cached. If the view is cached, control frame 103 may make the cached view the active frame visible to the user in display frame 101.

According to an embodiment of the invention, the control frame 103 may load the view into display frame 101 in a way that does not create a browser history entry. This is done so that navigating using the forward and back buttons may be controlled by one embodiment of the present invention. In one embodiment, the location.replace(URL) function may be used to load the view into display frame 101. This function may replace the current view with the view of the specified URL. When a document is replaced using the location.replace( ) function, the browser may replace the history entry of the frame with the URL of the new view. Thus, the forward and back buttons may no longer navigate to the previous view.

If the view has not been cached, a new frame may be created and a request for the view may be sent to the server containing the view. In one embodiment, control frame 103 may dynamically create a new IFRAME within display frame 101. An IFRAME is an HTML element which provides a mechanism for embedding data within an HTML document. The embedded data may be displayed in a subwindow of the web browser's window. Thus, IFRAMEs are more analogous to an object, such as an image, within an HTML document than to a typical HTML frame. When an IFRAME is created, it does not affect the browser's history (i.e. the browser does not add a history entry for the IFRAME).

When the server responds with the contents of the view, the view may be loaded into the new IFRAME. The code within control frame 103 may make the new IFRAME the active IFRAME displayed to the user in display frame 101. The code in control frame 103 may make the previous active IFRAME inactive so that it is not visible to the user in display frame 101. The code in control frame 103 may also update the universal resource locator (URL) of history frame 102, assigning history frame 102 a URL associated with the newly loaded view.

According to an embodiment of the invention, the history frame 102 may enable navigation between the various views loaded in frame environment 100 using the forward and back buttons typically found in web browsers. In one embodiment of the invention, history frame 102 may not be visible to the user. As described above, in one embodiment, the URL for the history frame 102 may be updated by the code in control frame 103 when a new view is displayed to the user in display frame 101. The URL of history frame 102 may correspond to the view being displayed in display frame 101. In one embodiment, JavaScript code in control frame 103 may update the URL of the history frame 102. Each time the URL of the history frame 102 is updated, the browser may add a new entry in the browser history for the new URL. As a result, the browser may view the contents of the history frame as a different history page each time the URL of the history frame is updated.

When a user clicks on the back or forward buttons in the browser, the browser may navigate to the previous or subsequent URL, respectively, within the browser's history. When a history page is loaded by the browser, code which may be embedded within the history page is executed by the browser. This code may notify control frame 103 to load the view associated with the history page into display frame 101.

I. Navigating within the Frame Environment by Clicking on Links

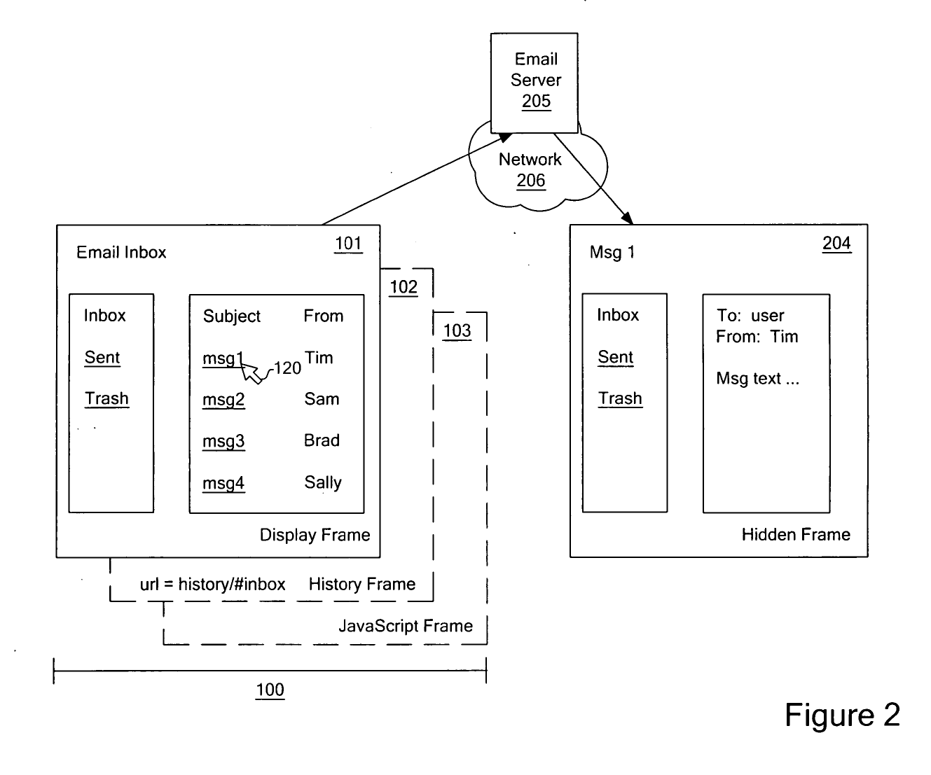

FIG. 2 illustrates how navigation within frame environment 100 may be accomplished when a user clicks on a link (or otherwise indicates a navigation request) within display frame 101 according to one embodiment of the invention. FIG. 2 includes email server 205, network 206, hidden frame 204, and frame environment 100, which may consist of display frame 101, history frame 102 and control frame 103. Frame environment 100, hidden frame 204 and email server 205 may have access to network 206. Just some examples of the network 206 may include small private networks, larger enterprise networks, the Internet, and combinations thereof.

As illustrated in FIG. 2, the current view displayed in display frame 101 may be an email inbox view. In one embodiment, the email inbox view may be displayed in an IFRAME within display frame 101. The inbox view may be the default view displayed to the user when the user logs into the email environment. In one embodiment of the invention, when a view is loaded into display frame 101, the contents of the view may also be cached. As illustrated, the inbox view may contain a number of links, including links to four messages, msg1, msg2, msg3 and msg4.

In one embodiment of the invention, when the user clicks on the msgl link, the code in control frame 103 may detect the user action and may perform the necessary steps to load the view for msg1 into display frame 101. In one embodiment, the control frame 103 may check the cache to determine if the view for msg1 has previously been cached. If the view is stored in the cache, the code in control frame 103 may load the view from the cache into display frame 101. As described above, control frame 103 may load the view in a way that does not create a browser history entry for the view. Loading the view from the cache may be advantageous since it does not require a server request for the msg1 contents from a remote server. As a result, the view may quickly be displayed to the user.

According to one embodiment, if the view is not found in the cache, the contents may be retrieved from a remote server. In this embodiment, email server 205 may contain the contents of msg1. Control frame 103 may create a new hidden frame 204 for the msg1 view. In one embodiment of the invention, hidden frame 204 may be an inline frame, or IFRAME. The browser may initiate a request for the HTML contents of the msg1 view from email server 205. Email server 205 may respond with the contents for the msg1 view which are loaded into hidden frame 204. Once the contents have been loaded, control frame 103 may make hidden frame 204 the active view in display frame 101, making hidden frame 204 the active visible frame within display frame 101. The msg1 contents may also be cached.

As described, the views may be loaded into display frame 101 such that the browser does not create history entries for the various views. This may be done so that the user navigations using the forward and back buttons may be controlled by the frame environment rather than the browser.

According to an embodiment of the invention, the present invention may enhance the operation of the forward and back buttons of the web browser using history frame 102 and control frame 103. As illustrated in FIG. 2, the URL for history frame 102 associated with the inbox view may be history/#inbox. This URL may identify the view being displayed in display frame 101. When the msg1 view is loaded into display frame 101, the URL of the history frame may be updated by control frame 103 to identify the new view that is being displayed in display frame 101. The code in control frame 103 may update the URL of the history frame by assigning the URL to the location object of the history frame. According to an embodiment, the following JavaScript code may be used to assign a new URL to the location object of a history frame:
history_frame.location=new_url

The browser may view the update of the URL of the history frame as a navigation to a new page. As a result, the browser may internally create a new history entry for the new history page. The URL for the history entry may be the URL assigned to the history frame. Thus, by changing the URL for the history frame as each new view is loaded in display frame 101, a new entry in the browser history may be added for each URL and a new history page may be created that is associated with each respective view. In one embodiment, each history page may be cached.

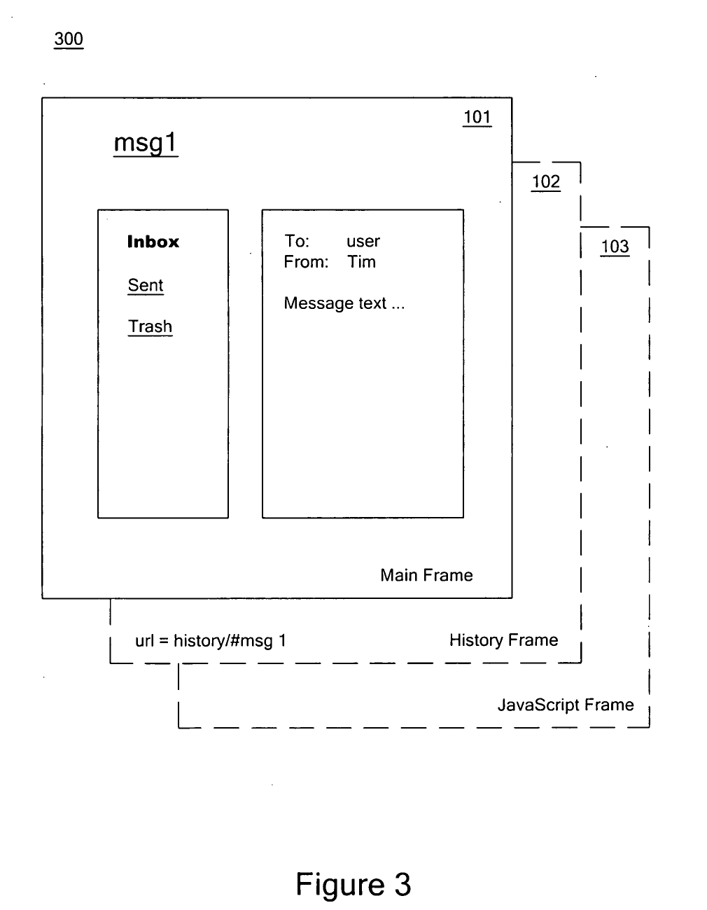

FIG. 3 illustrates an exemplary frame environment 300 that may result when the msg1 view has been loaded into display frame 101. As illustrated, the URL for history frame 102 may now be history/#msg1. As described above, this URL may identify the view that is displayed in display frame 101. In this example, the URL identifies the msg1 view.

II. Navigating the Frame Environment Via the Forward and Back Buttons on the Browser

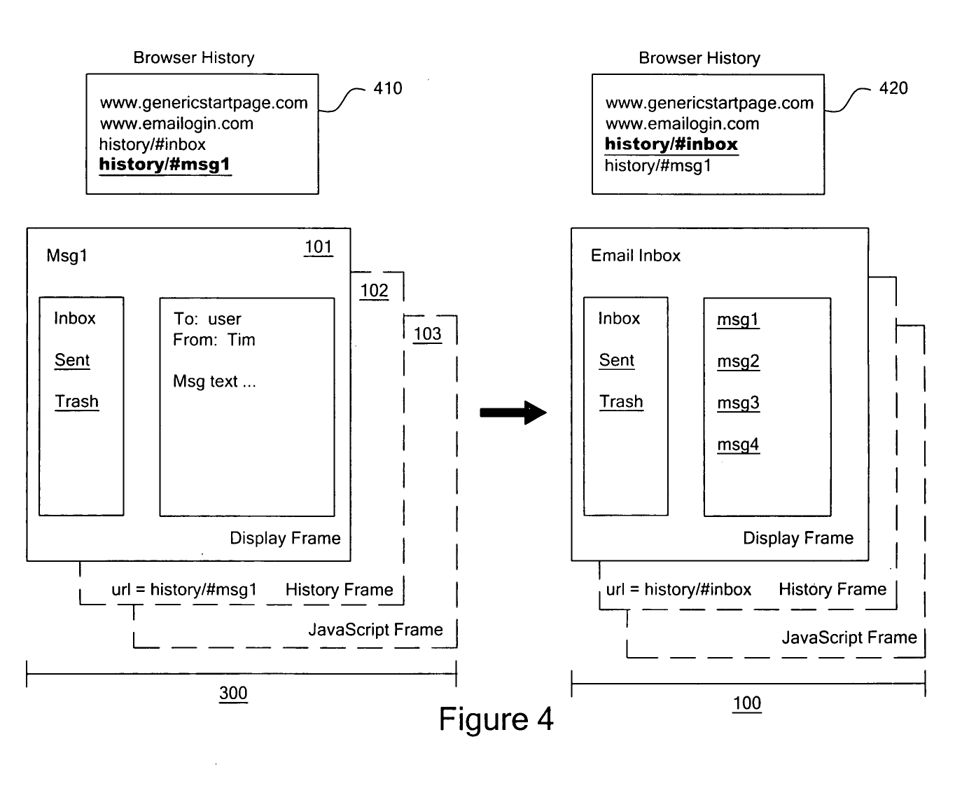

FIG. 4 illustrates how navigation within the frame environment may be accomplished using the forward and back buttons on the browser according to one embodiment of the invention. FIG. 4 shows frame environments 300 and 100 according to various embodiments. Above each frame environment is a representation of the browser's history entries. Browser history 410 may represent the browser history associated with frame environment 300 and browser history 420 may represent the browser history associated with frame environment 100.

According to an embodiment of the invention, browser histories 410 and 420 include mulitple history entries. The first entry in the list is the URL for the webpage www.genericstartpage.com. This is the first website loaded by the browser. The second entry in the browser history is www.emaillogin.com. This page is the login page for the user's email. The third entry in the browser history is www.emailstart.com. This web page defines the frameset for the frame environment. The fourth entry is history/#inbox. This is the URL of the history page, associated with the inbox view, that was added when the URL of the history frame was updated by control frame 103 when the inbox view was displayed. The fifth entry is history/#msg1. This is the URL for the history page associated with the msg1 view.

In this embodiment, the history entry highlighted in bold may correspond to the view currently displayed in the corresponding frame environment. As illustrated in FIG. 4, the fifth history entry in browser history 410 is highlighted in bold. This entry is the URL associated with the history page of the msg1 view. This entry may also correspond to frame environment 300 which displays the msg1 view in display frame 101.

According to an embodiment, when the user clicks on the browser's back button, the browser may navigate to the preceding URL in the browser history. In the embodiment illustrated in FIG. 4, the preceding URL is the history/#inbox URL. As described above, this URL may be the URL for the history page associated with the inbox view. When the browser navigates to this URL, the history page associated with the inbox view may be loaded into the history frame. Each history page may include code that is executed by the browser when the page is loaded in the history frame by the browser. This code may notify control frame 103 to load the view associated with the history page into display frame 101.

In one embodiment, the code within the history page may send the current URL of the history frame to control frame 103. When control frame 103 receives the URL, control frame may determine if the view associated with the URL Is loaded in a hidden frame within the web browser. If the view is loaded in a hidden frame, control frame may make the hidden frame the active, visible frame within display frame 101. Alternatively, control frame 103 may check to see if the view associated with the URL is located in the cache. If the contents of the view have been cached, control frame 103 may load the view from the cache into display frame 101. If the contents of the view are not found in the cache or in a hidden frame, control frame 103 may create a new hidden frame as described above in FIG. 2. When the view contents have been loaded into the hidden frame, control frame 103 may make the hidden frame the active, visible frame in display frame 101. Control frame 103 may also make the previously active frame hidden from the user within the browser.

In the embodiment illustrated in FIG. 4, the history page with the history/#inbox URL may be loaded into the browser when a user clicks on the browser's back button. The code in the history page may notify control frame 103 to load the inbox view. Control frame 103 may respond by loading the inbox view into display frame 101, resulting in frame environment 100. As illustrated in browser history 420, the history/#inbox URL is highlighted in bold. Note that there are now links preceding and following the current entry in the browser history. If the user clicks on the back button, the browser will load the www.emailstart.com URL. If the user clicks on the forward button, the URL for the history page associated with the msg1 view may be re-loaded into the history frame, which may result in the msg1 view being displayed in display frame 101 according to the embodiment described previously.

III. Association of a Frame Environment View with a History Entry in a Browser History

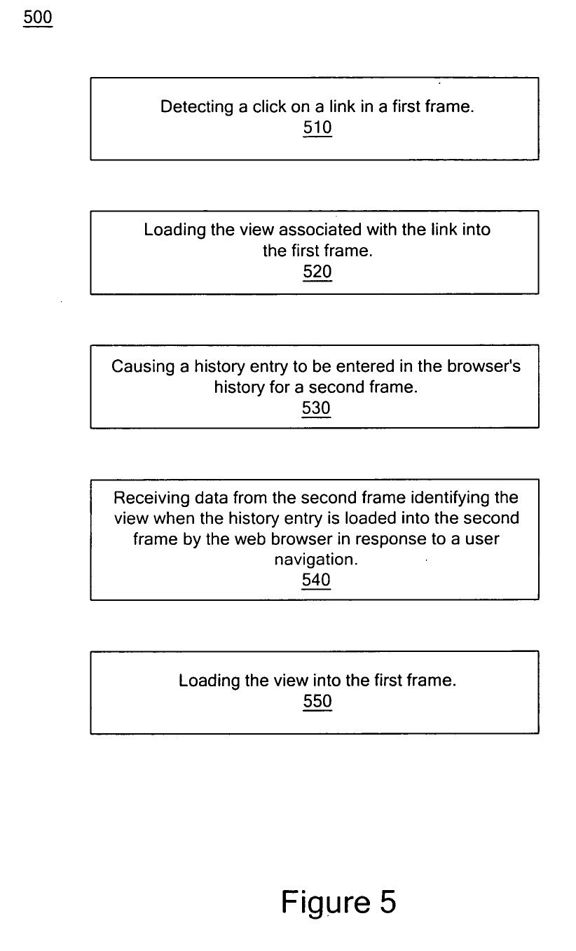

FIG. 5 is a flowchart illustrating an embodiment of a method for associating a view displayed in a frame environment with an entry in a web browser's history. As shown in the figure, a click on a link within a first frame is detected 510. In response, the view associated with the link may be loaded 520 into the first frame of the frame environment. In one embodiment, the first frame may display the view on a computer screen to a user.

In step 530, an action is performed causing a history entry to be entered in the browser's history for the web page, or history page, in a second frame. In one embodiment, the URL of the second frame may be updated, causing the browser to add the URL into the browser's history. In one embodiment, the URL may identify the view that was loaded in the first frame. By assigning a URL to the second frame that identifies the view, the view may be associated with the web page, or history page, in the second frame. As described below, this association may enable the view to be displayed in the first frame when the user navigates to the history page using the forward or back buttons on the browser.

When the history entry is loaded into the browser, data is received 540 from the second frame identifying the view. In one embodiment, the history page may be loaded by the browser when a user navigates to the history page using the forward or back button of the browser. When the user navigates using these buttons, the browser may reference the browser history to determine which URL to load into the browser. When the URL of the history page associated with a view is loaded, code within the history page may cause the second frame to initiate a transfer of data identifying the view that should be loaded into the first frame. In one embodiment, the data may include the URL, which identifies the view to be loaded.

In step 550, the veiw is loaded into the first frame.

While the present invention has been described with reference to certain embodiments, those skilled in the are will recognize that various modifications may be provided. For example, the frame environment of the present invention can be used to display any web page and is not limited to email pages. In addition, there are numerous programming languages, including JavaScript, that can be used to write the code utilized in the various frames. Variations upon and modifications to the embodiments are provided for by the present invention, which is limited only by the following claims.

1. A system for displaying a frame environment in a web browser, the system comprising:
a first frame adapted to display a view;
a second frame adapted to notify a third frame to load the view in the first frame when a history page associated with the view is loaded in the second frame by the web browser; and
a third frame for loading the view in the first frame.

2. The system of claim 1, wherein the second frame is assigned a universal resource locator (URL) that is added to the browser's history.

3. The system of claim 2 wherein the browser history comprises a list of websites the browser has previously displayed.

4. The system of claim 2 wherein the third frame detects a click of a link in the first frame and loads a second view, associated with the link, in the first frame.

5. The system of claim 4 wherein the third frame updates the URL of the second frame with a second URL when the third frame loads the second view.

6. The system of claim 5 wherein the second URL is added to the list of websites the browser has displayed.

7. The system of claim I wherein the history page is loaded into the second frame by the web browser when the user clicks on a navigation button in the browser.

8. A computer program product embodied on a computer readable medium for providing a frame. environment that controls navigation within the frame environment using a navigation button of a web browser, the computer program product comprising computer instructions for:
loading a view in a first frame;
assigning a universal resource locator (URL) identifying the view to a second frame; and
loading the view in the first frame when the URL identifying the view is loaded in the second frame by the web browser in response to a click of the navigation button of the web browser.

9. The computer program product of claim 8 further comprising computer instructions for detecting a click of a link in the first frame and loading a second view, associated with the link, in the first frame.

10. The computer program product of claim 9 further comprising computer instructions for updating the URL of the second frame with a second URL identifying the second view.

11. A method for associating a history entry in the browser's history with a view displayed in a first frame, comprising:
detecting a click on a link in a first frame;
loading the view associated with the link into the first frame without creating a history entry for the view; and
updating a URL of a second frame to cause the browser to add the URL to the browser history.

12. The method of 11 further comprising:
receiving data from the second frame identifying the view when the URL associated with the view is loaded into the second frame by the web browser; and
loading the view into the first frame.

13. The method of claim 12 wherein the URL associated with the view is loaded into the browser in response to a user clicking a navigation button on the web browser.

14. A method for associating a history entry in a web browser's history with a view displayed in a frame environment, comprising:
detecting a click on a link in a first frame;
loading the view associated with the link into the first frame;
causing a history entry associated with the view to be entered in the web browser's history for a second frame;
receiving data from the second frame identifying the view when the history entry associated with the view is loaded into the second frame by the web browser; and
loading the view into the first frame.

15. The method of claim 14 wherein the history entry associated with the view is loaded into the second frame in response to a user click on a navigation button in the web browser.

16. A method for providing a frame environment that displays a view to a user, comprising:
providing a first frame for displaying a view;
providing a second frame for loading the view in the first frame; and
providing a third frame for notifying the second frame to load the view in the first frame when a history page associated with the view is loaded by the browser in response to a user selection of a navigation function of the browser.

17. A method for controlling a navigation button of a web browser in a frame environment, comprising:
displaying a first view in a first frame;
navigating a second frame to a universal resource locator (URL) that identifies the first view, such that the URL is entered into the web browser's history;
causing the first view to be displayed in the first frame when the URL identifying the first view is loaded into the second frame in response to a user clicking on the navigation button of the web browser.

18. The method of claim 17 wherein the first view is loaded into the first frame in a way that does not create a history entry in the web browser.

19. The method of claim 17 wherein the navigation button is a forward button of the web browser.

20. The method of claim 17 wherein the navigation button is a back button of the web browser.

21. A method for controlling a navigation button of a web browser in a frame environment, comprising:
loading a view in a first frame such that the web browser does not record a history entry for the view;
causing a universal resource locator (URL) of a second frame to be loaded into the web browser's history, the URL associated with the view; and
causing the view to be loaded into the first frame when the web browser navigates the second frame to the URL associated with the view when a user clicks on the navigation button in a web browser.

22. The method of claim 21 wherein the URL identifies the view.

23. The method of claim 21 wherein the navigation button is a forward button of the web browser.

24. The method of claim 21 wherein the navigation button is a back button of the web browser.

25. A computer program product embodied on a computer medium for for controlling a navigation button of a web browser in a frame environment, the computer program product comprising instructions for:
displaying a first view in a first frame;
navigating a second frame to a universal resource locator (URL) that identifies the first view, such that the URL is entered into the web browser's history;
causing the first view to be displayed in the first frame when the URL identifying the first view is loaded into the second frame in response to a user clicking on the navigation button of the web browser.

26. A computer program product embodied on a computer readable medium for controlling a navigation button of a web browser in a frame environment, the computer program product comprising computer instructions for:
loading a view in a first frame such that the web browser does not record a history entry for the view;
causing a universal resource locator (URL) of a second frame to be loaded into the web browser's history, the URL associated with the view; and
causing the view to be loaded into the first frame when the web browser navigates the second frame to the URL associated with the view when a user clicks on the navigation button in a web browser.

27. A system for navigating between multiple views within a web browser, comprising:
a first view contained within the web browser and displayed to a user;
a second view contained within the web browser and hidden from the user;
a history page associated with the second view;
wherein the second view is displayed to the user when the history page is loaded by the web browser in response to a user navigation.

28. The system of claim 27 wherein an entry in a web browser history is created for the history page.

29. The system of claim 28 wherein the user navigation comprises clicking on a navigation button of the web browser.

30. The system of claim 27 wherein the browser does not create an entry in a web browser history for the first or second view.

31. The system of claim 27 wherein the first view is hidden within the web browser when the second view is displayed to the user.

32. A method for navigating between multiple views within a web browser, comprising:
displaying a first view within the web browser to a user;
associating a history page with the first view wherein the web browser adds an entry for the history page in a web browser history;
replacing the first view with a second view in response to a user navigation, wherein the first view is hidden from the user within the web browser;
displaying the first view to the user when the user navigates to the history page using a navigation button of the web browser.

33. The method of claim 32 wherein the browser does not create an entry in the web browser history for the first or second view.

34. The method of claim 32 wherein the history page is hidden from the user.

35. The method of claim 32, further comprising:
causing the second view to be hidden from the user within the web browser.
